(19) United States
(12) Patent Application Publication
(10) Pub. No.: US 2006/0255148 A1
(43) Pub. Date: Nov. 16, 2006

(54) Methods and apparatus for shock protection

(76) Inventors: Edward Barkan, Miller Place, NY (US); Mark Drzymala, Commack, NY (US); John Potter, Shirley, NY (US)

Correspondence Address: FAY KAPLUN & MARCIN, LLP, 15O BROADWAY, SUITE 702, NEW YORK, NY, 10038, US

(21) Appl. No.: 11/240,198

(22) Filed: Sep. 30, 2005

Related U.S. Application Data
(63) Continuation-in-part of application No. 11/130,729, filed on May 16, 2005.

(51) Int. Cl. G06K 7/10

(52) U.S. Cl. 235/462.36

(57) ABSTRACT

Described is a shock protection arrangement comprising a flexure coupled to a first magnet and a second magnet positioned adjacent the first magnet. The second magnet is oriented so that a repellant magnetic force generated by the second magnet resists motion of the first magnet when there is a predetermined distance between the first and second magnets.

### PRIORITY CLAIM

The present application is a continuation-in-part of U.S. patent application Ser. No. 11/130,729 entitled “Methods and Apparatus for Shock Protection” filed May 16, 2005, the entire disclosure of which is incorporated herein by reference.

### BACKGROUND

There are numerous standards for encoding numeric and other information in visual form, such as the Universal Product Codes (UPC) and/or European Article Numbers (EAN). These numeric codes allow businesses to identify products and manufactures, maintain vast inventories, manage a wide variety of objects under a similar system and the like. The UPC and/or EAN of the product is printed, labeled, etched, or otherwise attached to the product as a dataform.

Dataforms are any indicia that encode numeric and other information in visual form. For example, dataforms can be barcodes, two dimensional codes, marks on the object, labels, signatures, signs, etc. Barcodes are comprised of a series of light and dark rectangular areas of different widths. The light and dark areas can be arranged to represent the numbers of a UPC. Additionally, dataforms are not limited to products. They can be used to identify important objects, places, etc. Dataforms can also be other objects such as a trademarked image, a person's face, etc.

Scanners that can read and process the dataforms have become common and come in many forms and varieties. One embodiment of a scanning system resides, for example, in a hand-held gun shaped, laser scanning device. A user can point the head of the scanner at a target object and press a trigger to emit a light beam that is used to read, for example, a dataform, on the object. Another example is a scan engine, which is a self contained scanning module that can be added to different devices to give the devices scanning capabilities.

In an embodiment, semiconductor lasers are used to create the light beam because they can be small in size, they are low in cost and they do not require a lot of power. One or more laser light beams can be directed by a lens or other optical components along a light path toward an object that includes a dataform. The light path comprises scan elements including a pivoting scan mirror that sweeps the laser light back and forth across the object and/or dataform. The mirror can be part of a scan motor comprising a flexure, also known as a spring, and a permanent magnet. Flexures are used to pivot the mirror instead of bearings, because bearings wear out faster, thus making them less reliable.

The magnet is positioned in the vicinity of a drive coil, which oscillates the scan motor. There are numerous other known methods of sweeping the laser light, such as moving the light source itself or illuminating a plurality of closely spaced light sources in sequence to create a sweeping scan line. The scanner can also create other scan patterns, such as, for example, an ellipse, a curved line, a two or three dimensional pattern, etc.

The scanner also comprises a sensor or photodetector for detecting light reflected or scattered from an object and/or dataform. The returning light is then analyzed to obtain data from the object or dataform.

Scanners are often housed in portable or handheld equipment that can occasionally experience severe shock from being dropped, knocked off tables, etc. Therefore, it is important to protect the delicate components of a scan module from these and other types of shocks. For example, the flexures of a scan motor can become overstressed or bent permanently out of shape if not constrained during a shock event.

In existing scan modules, flexures are protected from damage from shocks by installing mechanical stops closely spaced around the moving mount on which the scan mirror is attached. During a shock, the flexure bends until the mirror mount hits one of the stops. The stops are positioned to stop the motion of the mirror mount before the flexure is damaged from being over-stressed. See, for example, U.S. Pat. Nos. 5,945,659 and 5,917,173, both of which are owned by Symbol Technologies, Inc.

Due to space constraints, sometimes stops are positioned in the light path of either the outgoing laser beam or the laser light that is reflected/scattered off the dataform. In either case, the position of the stop can degrade the scanner's performance. Accordingly, there is a desire for methods and apparatus for protecting scan module components from shock events by implementing stops that do not block the light path.

### SUMMARY OF THE INVENTION

The present invention relates to a shock protection arrangement comprising a flexure coupled to a first magnet and a second magnet positioned adjacent the first magnet. The second magnet is oriented so that a repellant magnetic force generated by the second magnet resists motion of the first magnet when there is a predetermined distance between the first and second magnets.

### BRIEF DESCRIPTION OF THE DRAWINGS

FIG. 1 shows an exemplary embodiment of a scan module according to the present invention; and

FIG. 2 shows a partial schematic view of the scan module of FIG. 1.

### DETAILED DESCRIPTION

There will now be shown and described in connection with the attached drawing figure an exemplary embodiment of the method and apparatus for providing a shock protection.

Sometimes scanners are dropped or knocked of tables by accident. Anticipating these events, the scanner is designed to withstand shock events. For example, some technical specifications require shock protection from drops of 6 feet or more. A flexure, also known as a spring, allows movement of the scan mirror, but can be overstressed and damaged in a shock event. Therefore, stops may be used to control the range of motion of the flexure.

In an embodiment of the invention, the stops are magnets which are positioned within the scanner to create magnetic fields which limit movement of the flexure. For example, an element of a scan module, such as for example, an extending members, a scan mirror, etc. may include a magnet or be magnetized such that disposition in the magnetic field limits the motion of the flexure and/or other scan elements. Limiting the motion of the scan elements protects the elements when a device that includes the scan module is dropped.

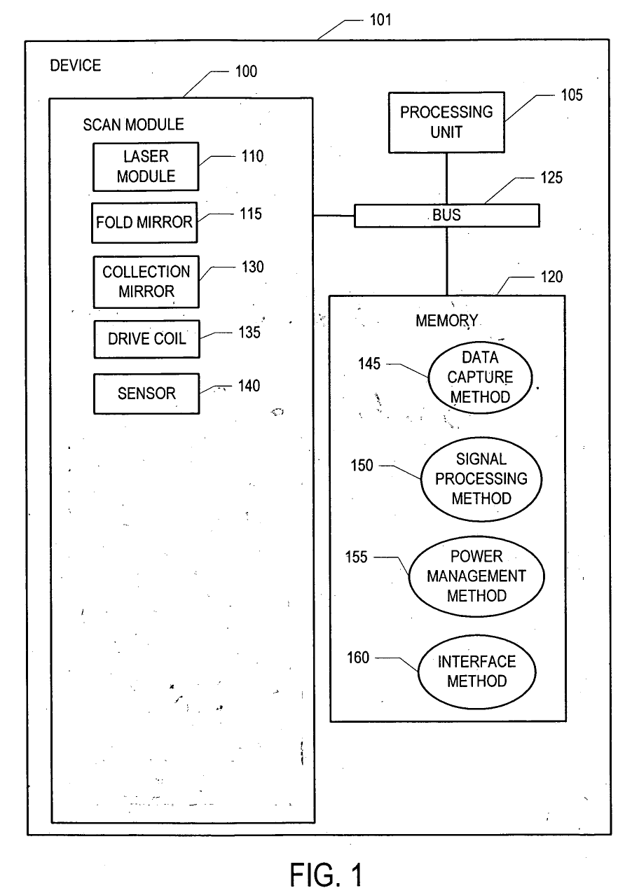

FIG. 1 illustrates an exemplary block diagram of a device 101 including a scan module 100, a processing unit 105 and a memory 120 coupled together by bus 125. The modules of device 101 can be implemented as any combination of software, hardware, hardware emulating software, and reprogrammable hardware. The bus 125 is an exemplary bus showing the interoperability of the different modules of the invention. As a matter of design choice there may be more than one bus and in some embodiments certain modules may be directly coupled instead of coupled to a bus 125. The device 101 can be, for example, a image/laser-based scanner, a mobile computer, a point of sale terminal, an RFID reader, etc, and the scan module can be, for example, a retroreflective scan engine.

Processing unit 105 can be implemented as, in exemplary embodiments, one or more Central Processing Units (CPU), Field-Programmable Gate Arrays (FPGA), etc. In an embodiment, the processing unit 105 may comprise a plurality of processing units or modules. Each module may include memory which may be preprogrammed to perform specific functions, such as, for example, signal processing, interface emulation, etc. In other embodiments, the processing unit 105 can comprise a general purpose CPU that is shared between the scan engine 100 and the device 101. In alternate embodiments, one or more modules of processing unit 105 can be implemented as an FPGA that can be loaded with different processes, for example, from memory 120, and perform a plurality of functions. Processing unit 105 can also comprise any combination of the processors described above.

Memory 120 can be implemented as volatile memory, non-volatile memory and/or rewriteable memory, such as, for example, Random Access Memory (RAM), Read Only Memory (ROM) and/or flash memory. The memory 120 stores methods and processes used to operate the device 101, such as, data capture method 145, signal processing method 150, power management method 155 and interface method 160.

In an exemplary embodiment of the invention, the device 101 can be a handheld scanner 101 comprising a trigger. When a scanning operation is initiated, for example the trigger is pressed, the scanner 101 begins data capture method 145. During the data capture method 145, laser light is emitted by the scanner 101, which interacts with a target dataform and returns to the scanner 101. The returning laser light is analyzed, for example, the received analog laser light is converted into a digital format, by the scanner 101 using signal processing method 150. Power management method 155 manages the power used by the scanner 101 and interface method 160 allows the scan engine 100 to communicate with the scanner 101.

The exemplary embodiment of FIG. 1 illustrates data capture method 145, signal processing method 150, interface method 160 and power management method 155 as separate components, but those methods are not limited to this configuration. Each method described herein in whole or in part can be separate components or can interoperate and share operations. Additionally, although the methods are depicted in the memory 120, in alternate embodiments the methods can be incorporated permanently or dynamically in the memory of processing unit 105.

Memory 120 is illustrated as a single module in FIG. 1, but in some embodiments image scanner 100 can comprise more than one memory modules. For example, the methods described above can be stored in separate memory modules. Additionally, some or all parts of memory 120 may be integrated as part of processing unit 105.

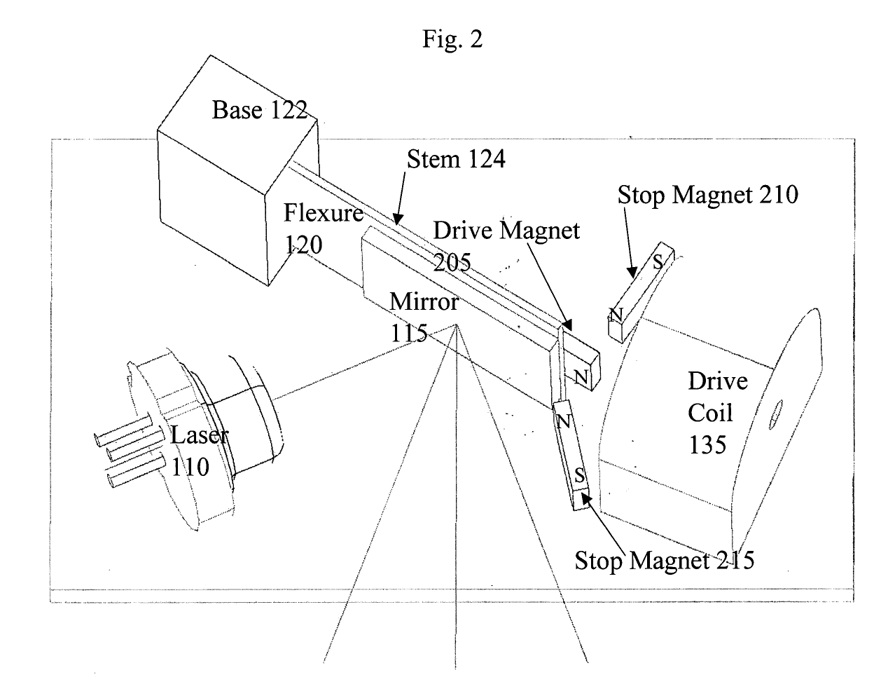

Scan module 100, which is shown schematically in FIG. 2, preferably includes a laser module 110, a mirror 115, a drive coil 135 and a flexure 120. The flexure 120 includes a base 122 which is fixed, for example, to a chassis housing in which the scan module 100 is situated. Those of skill in the art will understand that the chassis housing may be part of the device 101. Extending from the base 122 is a stem 124 which includes a front and rear faces with the mirror 115 situated on the front face and a drive magnet 205 coupled to the rear face and/or a distal end of the stem 124. Those of skill in the art will understand that the terms “front” and “rear” are relational terms used to describe faces of the stem 124, and that the front face may generally be a portion of the stem 124 which faces a direction of the dataform when the data capture method 145 is executed.

The drive coil 135 is preferably situated adjacent to the drive magnet 205 such that when the drive coil 135 is energized, a magnetic field generated thereby acts on the drive magnet 205 selectively repelling and attracting the drive magnet 205 to move the stem 124 of the flexure 120 from an initial position (e.g., rest) through a predetermined range of angles. That is, the stem 124 moves back and forth from its initial position as a result of magnetic forces acting on the drive magnet 205. Thus, the flexure 120 need not be formed of ferro-magnetic material. Rather the flexure 120 or at least the stem 124 may be formed from LIM or any other moldable material, such as, for example, silicone or a thermoplastic.

A first stop magnet 210 is disposed adjacent to the drive magnet 205 on a first side thereof. For example, as shown in FIG. 2, the first stop magnet 210 may be positioned rearwardly of the drive magnet 205 with a north pole of the first stop magnet 210 adjacent a north pole of the drive magnet 205. In this manner, during a shock event (e.g., drop, collision, etc.), rearward movement of the drive magnet 205 is limited by the repellent magnetic forces as the north poles of the first stop magnet 210 and the drive magnet 205 approach one another. Preferably, the drive magnet 205 is confined to a predetermined range of rearward movement from its initial position by the magnetic field created by the first stop magnet 210. Thus, during the shock event, the movement of the flexure 120 is limited to a degree selected to prevent fracture, overstressing, etc. Those of skill in the art will understand that the drive magnet 205 and the first stop magnet 210 may be positioned and polarly oriented in any manner (e.g., adjacent south poles) such that when the drive magnet 205 comes within a predetermined distance of the first stop magnet 210, the resulting magnetic field prevents further movement of the drive magnet 205 toward the first stop magnet 210.

In another embodiment, the scan module 100 further includes a second stop magnet 215 disposed adjacent to the drive magnet 205 on a second side thereof substantially opposite the first stop magnet 210. For example, the second stop magnet 215 may be positioned forward of the drive magnet 205 with a north pole of the second stop magnet 215 adjacent to the north pole of the drive magnet 205. Thus, when the drive magnet 205 comes within a predetermined distance of the second stop magnet 215, the magnetic field thereof repels the movement of the drive magnet 205 and the flexure 120 limiting movement of these components to a predetermined range.

When a data capture procedure (e.g., a scan) is initiated, the laser 110 emits a laser beam which is reflected by the mirror 115. While the beam is being reflected, the mirror 115 moves back and forth creating a scan line for reading a dataform (e.g., a barcode). The mirror 115 moves when the drive magnet 205 coupled thereto is acted upon by the magnetic field generated by the drive coil 135 which is energized when a scan is initiated.

After interacting with the dataform, a portion of the beam is reflected back toward the scan module 100. The returning light is received by the mirror 115 and directed (e.g., by reflection) toward a collection mirror (not shown) or a sensor (not shown) as would be understood by those skilled in the art. The collection mirror is preferably oriented and/or shaped (e.g., parabolic) to collect the returning light and concentrate it toward the sensor. In this embodiment a lens concentrates the returning light toward the sensor which may, for example, be a photodiode producing an electrical signal corresponding to the returning light. The electrical signal is analyzed by the processing unit 105 to decode the dataform.

According to the present invention, when a shock event occurs, the flexure 120 is prevented from overtravel, i.e., from travel away from its initial position beyond the predefined range. The overtravel may be either of rotational and lateral movement which, if it occurred, overstress and/or fracture the flexure 120 and could damage other components of the scan module 100. For example, if a shock event moves the scan module 100 forward, the second stop magnet 215 prevents movement of the flexure 120 by repelling the drive magnet 205. If the shock event moves the scan rearward, the first stop magnet 210 repels the drive magnet 205 limiting rearward movement of the flexure 120. When the scan module 100 is urged upward by a shock event, the flexure 120 and/or the drive magnet 205 contacts a printed circuit board (“PCB”) on top of the scan module 100 which prevents upward motion of the flexure 120 and the components coupled thereto. The PCB may cover and engage one or more components of the scan module 100. For example, the PCB may be attached to the base 122 and/or the drive coil 135. When the scan module 100 is urged downward by a shock event, the chassis housing prevents substantial downward movement of the flexure 120 and/or the drive magnet 205. In this embodiment, the flexure 120 is prevented from overtravel by one or more hardstops (i.e., the PCB and/or the housing) and one or more softstops (i.e., the first and/or second stops magnets). Alternatively, a further pair of magnets may be positioned adjacent upper and lower sides of the drive magnet 205. Thus, when the further pair of magnets is used in combination with the first and second stop magnets, four softstops prevent overtravel of the flexure 120. Those of skill in the art will understand that any number of magnets may be positioned around the drive magnet 205.

In another embodiment, the drive coil 135 may be energized during a shock event to position the flexure 120 against a hard and/or soft stop. The drive coil 135 may remain energized during the shock event to keep the flexure 120 against the stop preventing damage from excess motion during the shock event. The stop may be shaped in a predefined manner to prevent motion in all or substantially all shock directions (e.g., forward, rearward, upward, downward). For example, the stop may have a “glove” shape accepting a “hand” shape of the flexure 120. During the shock event, the drive coil 135 may be energized as a result of a predetermined condition detected by an accelerometer. For example, when the accelerometer detects a weightless condition indicating that the scan module has been dropped, the drive coil 135 is energized to position the flexure 120 against the stop. The drive coil 135 may then remain energized for a predetermined time and/or until the accelerometer indicates that normal weight has returned.

In an alternative exemplary embodiment of the present invention, a secondary coil (not shown) may be wound on top of the drive coil 135 and positioned adjacent the drive magnet 205. When energized, the secondary coil generates a magnetic force driving the drive magnet 205 toward the stop and the flexure 120 against the stop. In this embodiment, the accelerometer may control the energizing of the secondary coil.

While the exemplary shock protection systems of the invention have been described as part of a retoreflective scan system, the systems may also be used in non-retroreflective scan systems. Additionally, the systems are not limited to scanners. Any device that uses flexures and other delicate elements may use a similar system to protect its internal components from over-stress situations.

While the fundamental novel features of the invention have been shown and described as applied to preferred embodiments thereof, it will be understood that various omissions and substitutions and changes in the form and detail of the disclosed invention may be made by those skilled in the art without departing from the spirit of the invention. It is the intention, therefore, to be limited only as indicated by the scope of the claims appended hereto.

What is claimed is:

1. A shock protection arrangement, comprising:
a flexure coupled to a first magnet; and
a second magnet positioned adjacent the first magnet and oriented so that a repellant magnetic force is generated by the second magnet resisting motion of the first magnet when there is a predetermined distance between the first and second magnets.

2. The arrangement according to claim 1, wherein the flexure includes a base and a stem having first and second faces.

3. The arrangement according to claim 2, further comprising:
a mirror disposed on the first face, wherein the first magnet is disposed on one of the second face and a distal end of the flexure.

4. The arrangement according to claim 1, wherein the flexure is formed from at least one of a ferromagnetic material, LIM, silicone and thermoplastic.

5. The arrangement according to claim 1, wherein one of a north pole and a south pole of the second magnet is positioned adjacent a respective pole of the first magnet.

6. The arrangement according to claim 1, further comprising:
a third magnet positioned adjacent the first magnet and on a side of the first magnet substantially opposite to a side facing the second magnet, the third magnet being oriented in such a manner so that a repellant magnetic force is generated by the third magnet resisting motion of the first magnet when the first and third magnets are situated at a predetermined distance.

7. The arrangement according to claim 6, wherein one of a north pole and a south pole of the third magnet is positioned adjacent a respective pole of the first magnet.

8. The arrangement according to claim 1, further comprising:
at least one hardstop positioned adjacent the flexure preventing motion thereof.

9. The arrangement according to claim 8, wherein the at least one hardstop is one of a printed circuit board and a chassis housing.

10. The arrangement according to claim 6, further comprising:
at least one further magnet positioned adjacent the first magnet and on a side of the first magnet substantially perpendicular to a side facing the second magnet, the at least one further magnet being oriented in a such manner so that a repellant magnetic force is generated by the at least one further magnet resisting motion of the first magnet when the first and at least one further magnets are situated at a predetermined distance.

11. A system, comprising:
a first magnet;
a flexure coupled to the first magnet;
a mirror coupled to the flexure;
a laser shining a laser beam on the mirror;
a drive coil which, when energized, generating a magnetic field selectively attracting and repelling the first magnet, the flexure moving in combination with the first magnet, the mirror reflecting the laser beam through a predetermined angular range based on movement of the flexure; and
a second magnet positioned adjacent the first magnet and oriented in such a manner so that a repellant magnetic force generated by the second magnet resisting motion of the first magnet when the first and second magnets are situated at a predetermined distance.

12. The system according to claim 11, wherein the flexure includes a base and a stem having first and second faces.

13. The system according to claim 12, wherein the mirror is disposed on the first face and the first magnet is disposed on one of the second face and a distal end of the flexure.

14. The system according to claim 11, wherein the flexure is formed from at least one of a ferromagnetic material, LIM, silicone and thermoplastic.

15. The system according to claim 11, wherein one of a north pole and a south pole of the second magnet is positioned adjacent a respective pole of the first magnet.

16. The system according to claim 11, further comprising:
a third magnet positioned adjacent the first magnet and on a side of the first magnet substantially opposite to a side facing the second magnet, the third magnet oriented so that a repellant magnetic force is generated by the third magnet resisting motion of the first magnet when the first and third magnets are situated at a predetermine distance.

17. The system according to claim 16, wherein one of a north pole and a south pole of the third magnet is positioned adjacent a same pole of the first magnet.

18. The system according to claim 11, further comprising:
at least one hardstop positioned adjacent the flexure preventing motion thereof.

19. The system according to claim 18, wherein the at least one hardstop is one of a printed circuit board and a chassis housing.

20. The system according to claim 16, further comprising:
at least one further magnet positioned adjacent the first magnet and on a side of the first magnet substantially perpendicular to a side facing the second magnet, the at least one further magnet being oriented in such a manner so that a repellant magnetic force is generated by the at least one further magnet resisting motion of the first magnet when the first and at least one further magnets are situated at a predetermined distance.

21. A shock protection arrangement, comprising:
a flexure coupled to a magnet;
a first pair of magnets positioned adjacent substantially opposite sides of the magnet, the pair of magnets being oriented in such a manner so that opposing repellant magnetic forces are generated thereby resisting horizontal motion of the magnet; and
a second pair of magnets positioned adjacent substantially upper and lower faces of the magnet, the second pair of magnets being oriented in such a manner so that opposing repellant magnetic forces are generated thereby resisting vertical motion of the magnet.

22. A shock protection arrangement, comprising:
a flexure coupled to a magnet;
a stop positioned adjacent the flexure; and
a coil, upon a predetermined condition, generating a magnetic force driving the magnet toward the stop and the flexure against the stop.

23. The arrangement according to claim 22, wherein the predetermined condition is a shock event.

23. The arrangement according to claim 22, further comprising:
an accelerometer detecting the predetermined condition, the predetermined condition being a weightless condition.

24. The arrangement according to claim 22, wherein the coil is energized for a predetermined time.

25. The arrangement according to claim 22, wherein the stop is shaped to receive the flexure.

26. The arrangement according to claim 22, wherein the stop is one of a hard stop and a soft stop.

27. The arrangement according to claim 22, wherein the coil is a drive coil.

28. The arrangement according to claim 22, further comprising:
a drive coil positioned adjacent the magnet.
